(19) United States
(12) Patent Application Publication
(10) Pub. No.: US 2017/0339541 A1
(43) Pub. Date: Nov. 23, 2017

(54) SENDING EMERGENCY MESSAGES FROM A COMMUNICATION DEVICE TRIGGERED BY AN IMPACT EVENT

(71) Applicants: Joe Shen, Elmhurst, NY (US); Winifred Shen, Elmhurst, NY (US)

(72) Inventors: Joe Shen, Elmhurst, NY (US); Winifred Shen, Elmhurst, NY (US)

(21) Appl. No.: 15/160,581

(22) Filed: May 20, 2016

(51) Int. Cl. H04W 4/22; G08B 21/04; G08B 25/01; G08B 25/10

(52) U.S. Cl. CPC H04W 4/22; G08B 25/10; G08B 21/043; G08B 25/016; H04M 2250/10

(57) ABSTRACT

Embodiments provide techniques for sending emergency messages from a communication device triggered by an impact event. In accordance with one embodiment, a system is provided that includes a memory to store sensor data and a processor operatively coupled to the memory. The processor to receive inertial sensor data related an impact of a client device from an impact sensor associated with the client device. The sensor data indicates an amount of force applied to the client device with respect to the impact. A triggering event is detected based on the impact of the client device. A mode of the device is activated based on the triggering event. Responsive to detecting the triggering event, a message is generated that indicates a status of user associated with the client device. A message indicating a status of user associated with the device is generated with respect to the triggering event.

### TECHNICAL FIELD

The present disclosure is generally related to communication device systems, and is more specifically related to sending emergency messages from a communication device triggered by an impact event.

### BACKGROUND

On a snowy night, an 80-year-old man, Mr. Woodworth, went outside to shovel snow with his flip phone. Mrs. Woodworth, his wife, did not go with him because she had a cold. Unfortunately, he collapsed in their garden while his wife was watching TV in the living room. They were merely 50 feet away from one another. During commercial break, the wife went outside and found her husband dead from a heart attack. In the same night, a woman drove on a winding road in a remote mountain area. Her car slipped off the road and crashed 30 yards under the roadside. She was in a coma for several hours then frozen to death, no one knew, and she could not use the smart phone in her pocket to call 911. In another example, in a president suite of a 5-star hotel in Thailand, a famous pop singer suffocated to death with holding a cordless phone while her boyfriend went out to buy her asthma medicine. In yet another example, two masked guys grabbed a boy who was playing a video game on his phablet while walking home from school and slammed the boy into a van. Thereafter, the van disappeared in a few seconds.

Although there are many systems capable of alerting emergency services to an emergency event, some users may be unable to activate the system or may be incapacitated due to the nature of the emergency. While there are some emergency event systems that can be activated in response to certain events, such as a car crash, these typically focus on vehicle display crash messages and are not equipped with safety systems to protect passengers who are not driving or instances when the car is not activated. Moreover, these systems require costly monthly monitoring services and reporting infrastructures.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

The present disclosure is illustrated by way of examples, and not by way of limitation, and may be more fully understood with references to the following detailed description when considered in connection with the figures, in which:

FIG. 1 depicts a high-level component diagram of an example computer system in accordance with one or more aspects of the present disclosure.

FIG. 2 depicts a pictorial diagram of a system in accordance with aspects of the disclosure.

FIG. 3 depicts a flow diagram of a method for sending emergency messages from a communication device triggered by an impact event in accordance with one or more aspects of the present disclosure.

FIG. 4 depicts a flow diagram of another method in accordance with one or more aspects of the present disclosure.

FIG. 5 depicts a flow diagram of yet another method in accordance with one or more aspects of the present disclosure.

FIG. 6 depicts a block diagram of an example computer system operating in accordance with one or more aspects of the present disclosure.

### DETAILED DESCRIPTION

Described herein are techniques for sending emergency messages from a communication device triggered by an impact event, such as during an emergency event, which is detected by an impact of a communication device. In one embodiment, a system can be installed on the communication device that can send the emergency message (e.g., via a text message, e-mail, phone call, etc.) when a triggering event is detected by the communication device, such as an impact of a certain amount of force. This emergency message may include information indicating a location and nature of the emergency, as well as other information. The emergency message may be comprised of a pre-recorded phone message or pre-written text message that can include relevant medical information regarding the user of the communication device. For example, when the emergency message is triggered, the system may retrieve electronic medical records from a provider associated with the user.

In some situations, if the communication device is in an inactive mode (e.g., airplane mode, hibernate mode), the system may switch the communication device to an active mode before sending the emergency message. For example, upon detecting that an emergency event has occurred based on information detected by one or more sensors of the communication device, the system may determine whether a current state of the communication device is in a mode that is incapable of sending a message. In such a case, the system may switch the mode of the communication device to an active mode so that the message can be sent. In one embodiment, activation of the mode of the client device may establishes a network connection for sending message in the active mode, such as activating all wireless radios , including the call function, data services, Radio Frequency, Bluetooth, and Wi-Fi of the communication device. In some embodiments, the system may also retrieve a current location of the communication device based on a Global Positioning System (GPS) component of the device and add the current location to the message before it is sent to a receiver device. Thus, the message not only indicates that an emergency event occurred, but also indicates the location of the emergency so that response services can be quickly dispatched.

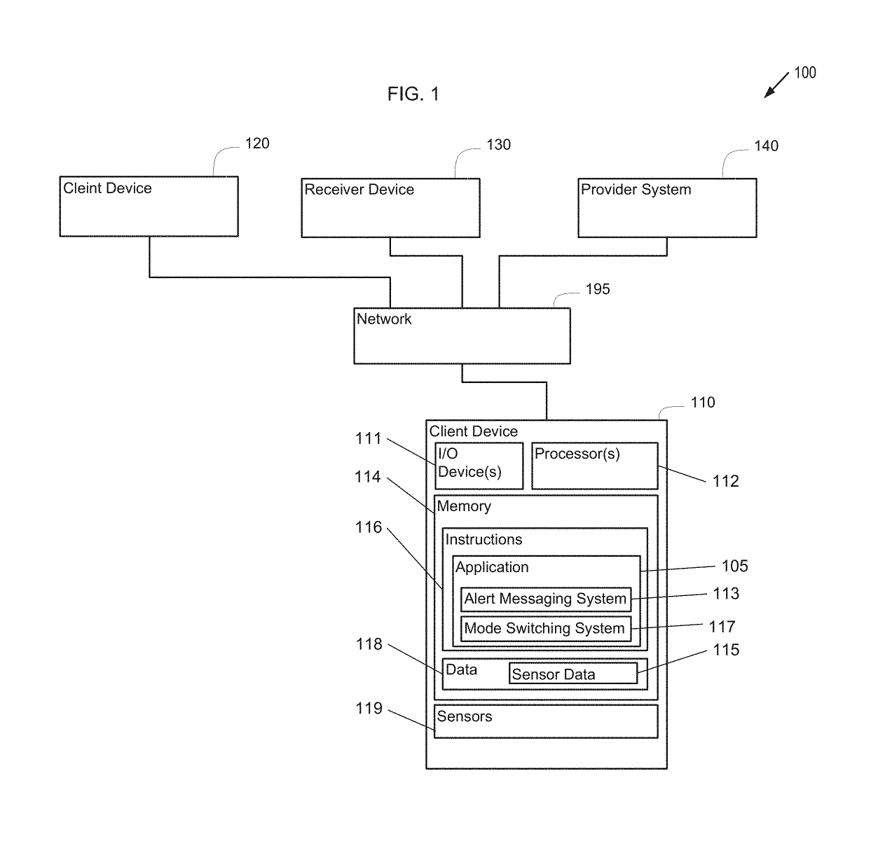

FIG. 1 depicts a high-level component diagram of an exemplary computer system 100 that may be used to implement one or more aspects of the present disclosure. As shown, the computer system 100 may include one or more computing devices, such as client devices 110 and 120 and a receiver device 130 coupled to a network 195. In some embodiments, an application 105 associated with the client device 110 may be utilized for sending emergency messages triggered by an impact event detected by using the client device 110. In some embodiments, the application 105 may be installed and/or a service may be selected in order to obtain the benefits of the techniques described herein.

In an implementation, the application 105 may be downloaded onto the client device 110. For example, a user may elect to download the application from a service associated with an online server. The client device 110 may transmit a request for the application over network 195 and, in response, receive the application 105 from the service. The application 105 may be installed locally on the client device 110. Alternatively, the application 105 can be stored at the service and may be accessed through the client device 110, for example, via a mobile web browser. By using the application 105, the client device 110 may detect whether a certain amount of force has been applied to the client device with respect to an impact of the device in view of a movement from a first position to a second position. In an alternative implementation, the application 105 may be a firmware embedded in communication device.

The computing devices, such as client device 110, may include one or more I/O (input/output) devices 111, processors 112, memory 114, and other components typically present in general purpose computers. “Processor” or “Processing device” herein refers to a device capable of executing instructions encoding arithmetic, logical, or I/O operations. In one illustrative example, a processor may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). “Memory” herein refers to a volatile or non-volatile memory device, such as RAM, ROM, EEPROM, or any other device capable of storing data. “I/O device” herein refers to a device capable of providing an interface between a processor and an external device capable of inputting and/or outputting binary data. Although, for simplicity, a single processor 112 is depicted in FIG. 1, in some other embodiments computer system 100 may comprise a plurality of processors. Similarly, in some other embodiments computer system 100 may comprise a plurality of I/O devices, rather than a single I/O device 111.

The computer system 100 may include one or more of a server, a mainframe, a workstation, a personal computer (PC), a mobile phone, a palm-sized computing device, etc. The network 195 may be a private network (e.g., a local area network (LAN), Wi-Fi, Bluetooth, Radio Frequency), a wide area network (WAN), intranet, etc.) or a public network (e.g., the Internet). Computer system 100 may run “host” software that manages the hardware resources of the computer system and that provides functions such as interprocess communication, scheduling, memory management, and so forth.

Instructions 116 of the client device 110 may be a set of instructions to be executed directly (such as machine code) or indirectly (such as scripts) by the processor 112. In that regard, the terms “instructions,” “steps” and “programs” may be used interchangeably herein. The instructions 116 may be stored in object code format for direct processing by the processors 112, or in another computer language including scripts or collections of independent source code modules that are interpreted on demand or compiled in advance.

Data 118 may be retrieved, stored or modified by processors 112 in accordance with the instructions 116. For instance, although the present disclosure is not limited by a particular data structure, the data 118 may be stored in computer registers, in a relational database as a table having a plurality of different fields and records, XML documents, or flat files. The data 118 may also be formatted in a computer-readable format such as, but not limited to, binary values, ASCII or Unicode. By further way of example only, the data 118 may comprise information sufficient to identify the relevant information, such as numbers, descriptive text, proprietary codes, pointers, references to data stored in memory or information that is used by a function to calculate the relevant data. For example, the data 118 may include sensor data 115 to identify readings and/or output from one more sensors 119.

In some embodiments, the sensors 119 include one or more components to detect and measure the orientation, vibrations, impacts, accelerations or forces applied to the client device 110. For example, the sensors 119 may include a combination of one or more inertial sensors, such as an accelerometer, gyroscope or compass, a shock detector or other types of sensors used to detect and measure activates or state information of a communication device, such as an amount of force applied to the client device 110. In some embodiments, the sensors 119 may be used to detect when the client device moves from a first position to a second position. For example, the sensors 119 may produce sensor data 115 outputs that can be used to determine if the client device 110 is dropped or otherwise suddenly comes into contact with a surface (e.g., ground level). In some embodiments, the sensors 119 may be used to measure the amount of force applied to a region of the client device 110 upon impact. From these sensors 119, it may be possible to determine a velocity of the client device 110 when the client device 110 impacts a surface.

In some embodiments, the sensors 119 may also include components to determine the location of the device. In one embodiment, the sensors 119 include a positioning component or receiver (e.g., a GPS component). By way of example only, the positioning component may include software for determining the position of the device based on signals received at the client device 110, such as signals received by a cell phone's antenna from one or more cell phone towers or longitude/latitude coordinates from a GPS system. In that regard, the provisioning of location identification data may occur automatically based on information received from such a component. In other embodiments, a physical address associated with a landline can be traced by the sensors 119 to determine a location of the client device 110.

To facilitate the sending of emergency messages from a communication device triggered by an impact event, the instructions 116 of the client device 110 may include an alert messaging system 113. The alert messaging 113 may generate and transmit emergency messages for a user based on a triggering event, such as an impact on the device. The client device 110 may also include a mode switching system 117 for switching a mode of the client device 110 from a state where the message can be transmitted by the device 110. The functionality of the systems 113 and 117 can exist in a fewer or greater number of modules than what is shown, with such modules residing at one or more computing devices, which may be geographically dispersed. The systems may be operable in conjunction with components of the client device 110 from which it may receive sensor data 115, location data and other relevant information regarding the device 110.

In some embodiments, when an impact event on the device triggers an emergency message to be generated, the system transmits this message to a receiver device 130. In one embodiment, the client device 110 may send a signal comprising the message to a computer terminal at a monitoring service station via a network connection over network 195. In another embodiment, the client device 110 may send the message to another client device, such as client device 120. This other client device 120 may be the device of a friend or spouse of the user associated with client device 110. In an alternative embodiment, the client device 110 may dial a pre-programed phone number to transmit a pre-recorded text or voice message indicating that an emergency event occurred with the user associated with client device 110.

The message transmitted by the client device 110 to the receiver device 130 may be comprised of various types of communications, such as a voice message, a text message, an e-mail, a video message, etc. In some embodiments, this message may be pre-recorded or pre-written and stored in the memory 114 of the device. In one embodiment, the message may include location information associated with the device 110. For example, once an impact occurs with the client device 100, the sensors are accessed to determine a location of the device at that time. This location is then added to the message in order to direct a receiver of the message to the location of the emergency event associated with the impact. In other embodiments, a physical address associated with the location may be identified and added to the message.

In some embodiments, system 100 may further include a source, such as provider system 140 that provides information about the user associated with client device 110. One possible source of information is an electronic medical record from an insurance provider. In this regard, when an impact event is detected, the client device 110 may use pre-configured login credentials to access electronic health records associated with the user. A portion or all of these records are then added to the message for transmission to the receiver device 130 along with other relevant information regarding the user and the emergency event that triggered the alert.

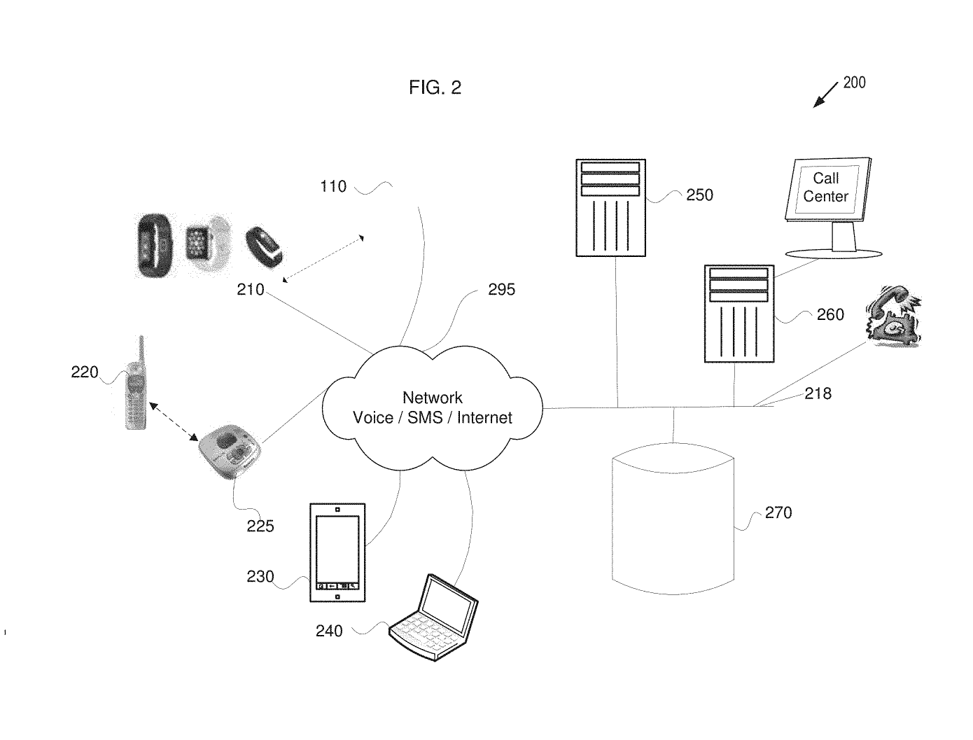

FIG. 2 depicts a pictorial diagram of a system 200 in accordance with aspects of the disclosure. As shown, system 200 depicts various devices that can be used alone or in a networked configuration. For example, FIG. 2 illustrates a network 295 having a plurality of computing devices, such as client device 110, and other types of computing devices, such as smartwatch devices/smartware devices/biometric devices 210, a cordless phone 220 with a base station 225, a tablet 230 and a laptop/netbook 240 as well as computing receiving devices 250 and 260 (e.g., computing devices that can be located at a number of different receiving stations). These various devices may be interconnected via a network or direct connection 218 and/or may be coupled via a communications network 295 (e.g., a LAN, WAN, the Internet, etc. that may be wired or wireless). In some embodiments, the computing devices may communicate with each other before accessing the communication network 295. For example, the smartwatch devices/smartware devices/biometric devices 210 may communicate via a Bluetooth connection with client device 110 to access network 295. For another example, a cordless phone 220 may communicate via 2.4 GHz frequency band with a base station 225.

Each device may include, for example, user input devices such as a keyboard and mouse and/or various other types of input devices such as pen-inputs, joysticks, buttons, touch screens, etc., as well as a display, which could include, for instance, a CRT, LCD, plasma screen monitor, TV, projector, etc. Each device may be a personal computer, application server, etc. By way of example only, computing device 110 may be a mobile phone while computing device 260 may be a server. Databases, such as database 270, may be accessible to one or more of the computing devices or other devices of system 200. The database 270 may comprise data associated with the client devices as well as store messages transmitted via system 200.

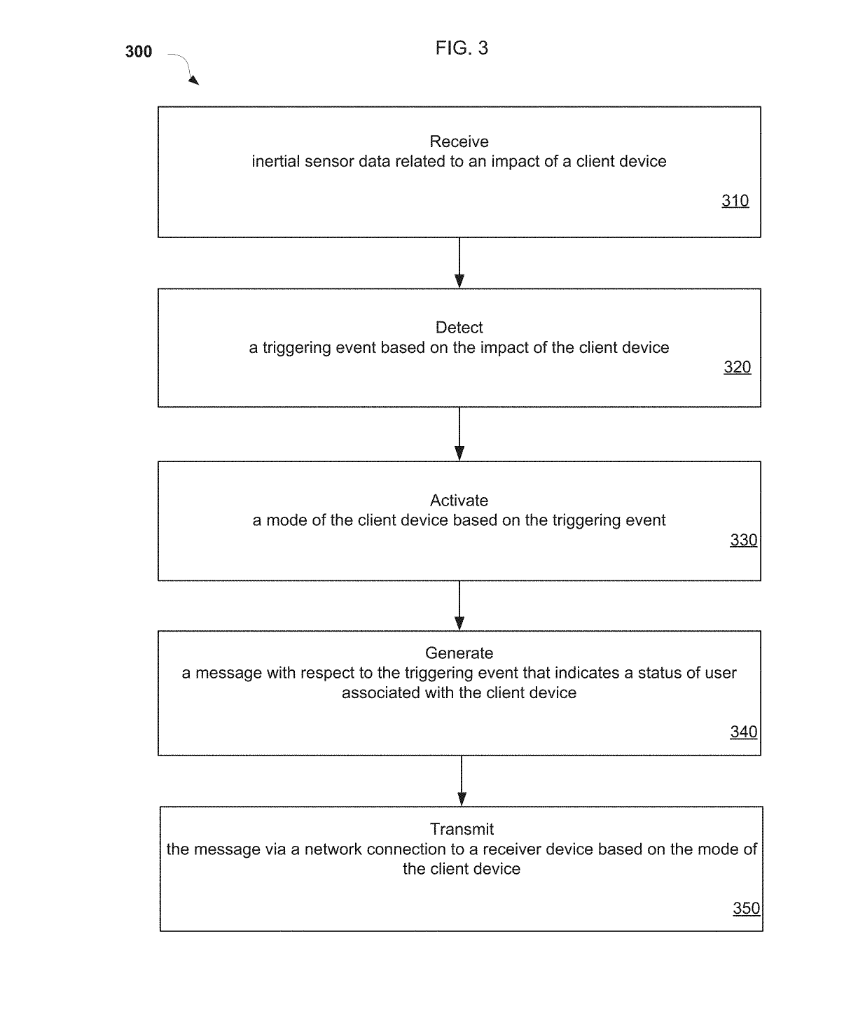

FIG. 3 depicts a flow diagram of a method 300 for sending emergency messages from a communication device triggered by an impact event in accordance with one or more aspects of the present disclosure. In one embodiment, the processor 112 of FIG. 1 may perform method 300 in order to send emergency messages from a communication device (e.g., client device 110) triggered by an impact event in view of one or more sensors (e.g., sensors 119). The method 300 may be performed by processing logic that may comprise hardware (circuitry, dedicated logic, etc.), software (such as is run on a computer system or a dedicated machine), or a combination of both. Alternatively, in some other embodiments, some or all of the method 300 may be performed by other components of computer system 100. It should be noted that blocks depicted in FIG. 3 can be performed simultaneously or in a different order than that depicted.

Method 300 begins at block 310 where inertial sensor data related an impact of a client device is received. The inertial sensor data may indicate an amount of force applied to the client device with respect to the impact. In block 320, a triggering event based on the impact is detected. In block 330, a mode of the client device is activated based on the triggering event. For example, it may be determined whether a current state of the client device is in at least one of: a hibernation mode, airplane mode or standby mode. Based on the current state, the mode of the client device may be switched to an active mode. In some embodiments, activation of the mode of the client device establishes a network connection for sending message in the active mode. A message with respect to the triggering event may be generated in block 340. The message indicates a status of user associated with the client device. For example, the message may include a portion of health records associated with the user or a location of the user when the triggering event was detected. In block 350, the message is transmitted, via the network connection, to a receiver device based on the active mode of the client device.

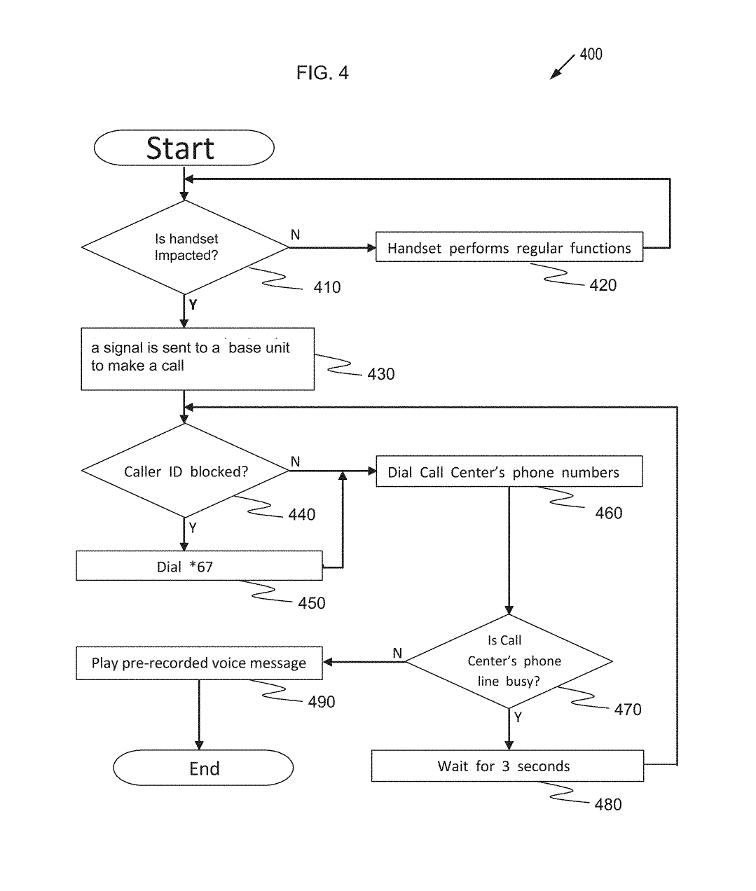

FIG. 4 depicts a flow diagram of another method 400 in accordance with one or more aspects of the present disclosure. In one embodiment, the processor 112 of FIG. 1 may perform method 400 in order to send emergency messages from a communication device (e.g., client device 110) triggered by an impact event in view of one more sensors (e.g., sensors 119). The method 400 may be performed by processing logic that may comprise hardware (circuitry, dedicated logic, etc.), software (such as is run on a general purpose computer system or a dedicated machine), or a combination of both. Alternatively, in some other embodiments, some or all of the method 400 may be performed by other components of computer system 100. It should be noted that blocks depicted in FIG. 4 can be performed simultaneously or in a different order than that depicted.

Method 400 begins at block 410 where it is determined whether a handset, such as client device 110, is dropped or otherwise experiences an impact event. For example, output from a sensor associated with the handset may be analyzed to determine if the handset made an impact with a surface, such as the ground. If the handset is not dropped, method 400 proceeds to block 420 where the handset continues to perform its regular functions. Otherwise, method 400 proceeds to block 430. In block 430, a signal is sent to a base unit triggering the handset to make a call. For example, a system associated with the base unit may dial a pre-determined number in view of the impact event.

Method 400 branches depending on whether caller id is blocked for the handset. If the caller id is blocked, method 400 proceeds to block 450 to send a signal (e.g., dial *67) to remove the caller id block. Otherwise, method 400 proceeds to block 460 to contact the pre-determined number, for example, a call center's phone number. In some embodiments, the pre-determined number can be associated with a family member, friend or other types of emergency service and/or contact numbers. In some embodiments, the system may interface with the base unit of the handset to dial the pre-determined number. If it is determined in block 470 that the call center's line is busy, then method 400 proceeds to block 480 to wait for a period of time (e.g., 3 seconds) before trying to contact the call center again. Otherwise, method 400 proceeds to block 490 where a per-recorded voice message is played. For example, a pre-recorded emergency message may be stored in the base unit indicating that an emergency event has occurred. In some embodiments, the message may also include a location of the emergency event and other relevant medical data for a user associated with the handset.

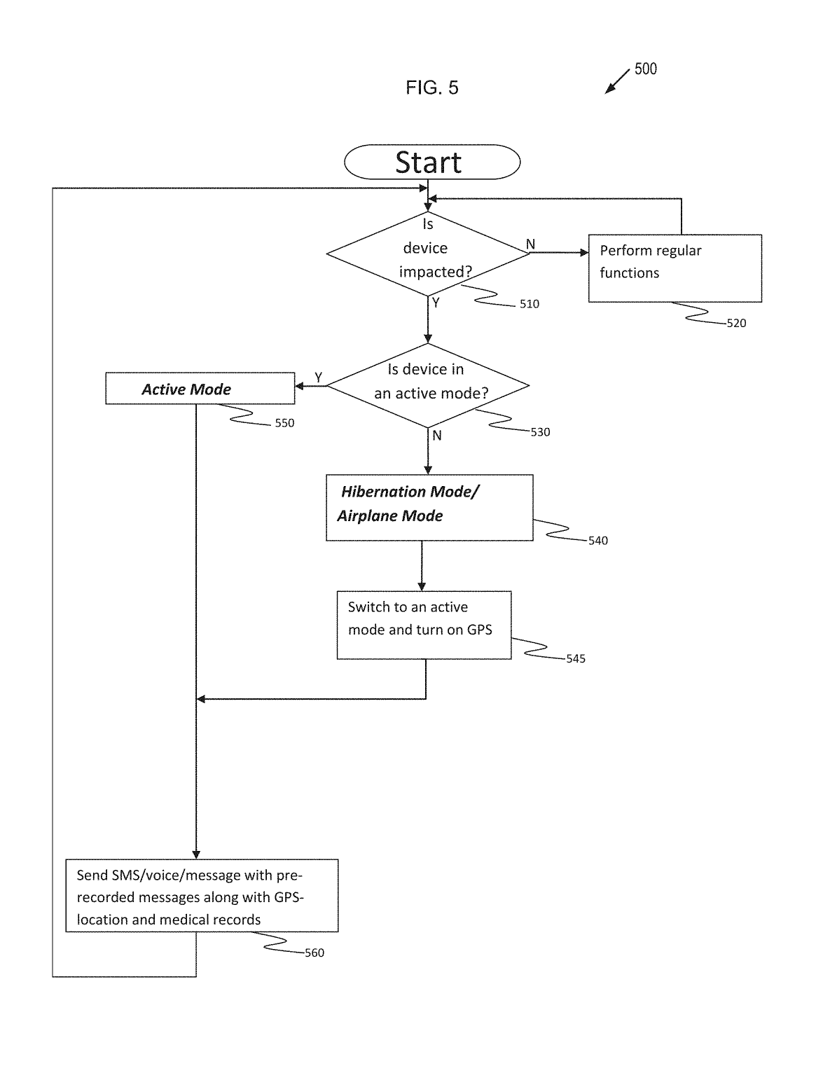

FIG. 5 depicts a flow diagram of yet another method 500 in accordance with one or more aspects of the present disclosure. In one embodiment, the processor 112 of FIG. 1 may perform method 500 in order to send emergency messages from a communication device (e.g., client device 110) triggered by an impact event in view of one more sensors (e.g., sensors 119). The method 500 may be performed by processing logic that may comprise hardware (circuitry, dedicated logic, etc.), software (such as is run on a general purpose computer system or a dedicated machine), or a combination of both. Alternatively, in some other embodiments, some or all of the method 500 may be performed by other components of computer system 100. It should be noted that blocks depicted in FIG. 5 can be performed simultaneously or in a different order than that depicted.

As shown in FIG. 5, at block 510 a determination is made whether a communication device, such as a cellular phone, experienced an impact event (e.g., dropped). If it is determined that the communication device did not experience an impact event, method 500 proceeds to block 520 where the communication device continues to perform regular functions. Otherwise, method 500 may proceed to block 530 where it is determined whether the device is in an active mode. Method 500 branches to block 540 if the device is not in an active mode, such as hibernation mode or airplane mode. Otherwise, method 500 may proceed to block 550 if the device is in an active mode (e.g., the device is able to send and receive messages). If the device is not in an active mode, method 500 proceeds to block 545 wherein the device is switched to an active mode and the GPS mode of the device is turned on. In some embodiments, when the device is switched from an inactive mode to an active mode this also establishes a network connection for the device to send message. For example, the active mode of the device may turn on an antenna of the device associated with a cellular network or other types of networks for sending and receiving messages. Thereafter, method 500 sends a prerecorded message, such as an SMS, voice, text message, etc., along with a GPS-location and relevant medical records to a receiving device in block 560. The message indicates that an emergency event has occurred with a user of the device.

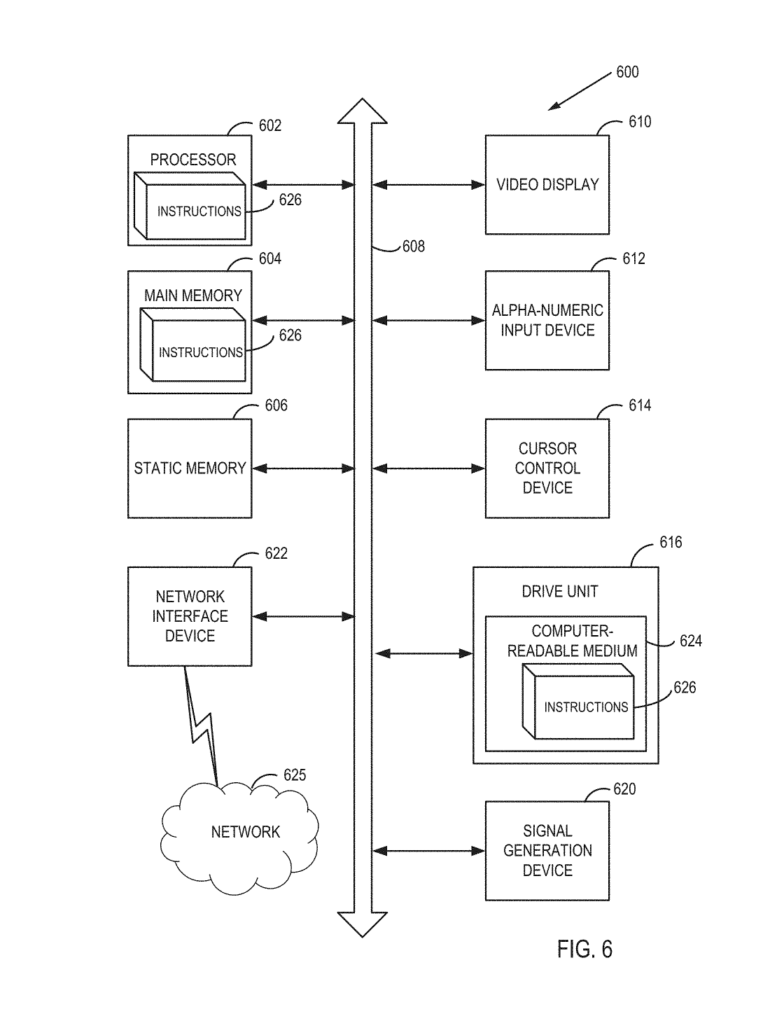

FIG. 6 depicts an example computer system 600 which can perform any one or more of the methods described herein. In one example, computer system 600 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a drive unit 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions that may include instructions to execute instructions 626 for performing the operations and steps discussed herein. For example, in one embodiment, the instructions 626 may perform the methods of flow diagram 300 of FIG. 3, flow diagram 400 of FIG. 4 and flow diagram 500 of FIG. 5.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The drive unit 616 or secondary memory may include a non-transitory computer-readable medium 624 on which is stored one or more sets of instructions 626 (e.g., instructions for the instructions 626) embodying any one or more of the methodologies or functions described herein. Instructions for the instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622. The instructions 626 may further be transmitted or received over a network 625 via the network interface device 622.

The non-transitory computer-readable storage medium 624 may also be used to store the instructions 626 persistently. While the computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, non-transitory computer-readable storage mediums, solid-state memories, optical media, and magnetic media.

The instructions 626, components and other features described herein can be implemented as discrete hardware components or integrated in the functionality of hardware components such as ASICS, FPGAs, DSPs or similar devices. In addition, the instructions 626 can be implemented as firmware or functional circuitry within hardware devices. Further, the instructions 626 can be implemented in a combination hardware devices and software components. For example, the functionality of this module can exist in a fewer or greater number of modules than what is shown, with such modules residing at one or more computing devices that may be geographically dispersed. The modules may be operable in conjunction with network 625 from which it may receive and provide relevant information regarding geometries.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “determining”, “allocating”, “notifying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A system comprising:
a memory to store sensor data; and
a processing device, operatively coupled to the memory, to:
receive inertial sensor data related an impact of a client device from an impact sensor associated with the client device, the inertial sensor data indicating an amount of force applied to the client device with respect to the impact;
detect a triggering event based on the impact of the client device;
activate a mode of the client device based on the triggering event;
responsive to detecting the triggering event, generate a message indicating a status of user associated with the client device; and
transmit, via a network connection associated with the client device, the message to a receiver device based on the mode of the client device.

2. The system of claim 1, wherein the impact sensor is built into the client device or in separate device that is in wireless communication with the client device.

3. The system of claim 1, wherein activation of the mode of the client device establishes the network connection.

4. The system of claim 1, wherein the message comprises at least one of: a voice message, text message, e-mail or phone call.

5. The system of claim 1, wherein the message comprises at least one of: a pre-recorded message or a pre-written message.

6. The system of claim 1, wherein the processing device further to:
determine a location of the client device at a time of the triggering event; and
add the location of the client device to the message.

7. The system of claim 6, wherein the processing device further to identify a physical address associated with the location.

8. The system of claim 1, wherein the processing device further to:
access a health record associated with the user; and
add a portion of the health record to the message.

9. The system of claim 1, wherein to activate the mode of the client device, the processing device further to:
determine whether a current state of the client device is in at least one of: a hibernation mode, an airplane mode or a standby mode; and
switch the mode of the client device to an active mode based on the current state.

10. A method comprising:
receiving, by a processing device, inertial sensor data related an impact of a client device from an impact sensor associated with the client device, the inertial sensor data indicating an amount of force applied to the client device with respect to the impact;
detecting, by the processing device, a triggering event based on the impact of the client device;
activating, by the processing device, a mode of the client device based on the triggering event;
responsive to detecting the triggering event, generating a message indicating a status of user associated with the client device; and
transmitting, via a network connection associated with the client device, the message to a receiver device based on the mode of the client device.

11. The method of claim 10, wherein the impact sensor is built into the client device or in separate device that is in wireless communication with the client device.

12. The method of claim 10, wherein activation of the mode of the client device establishes the network connection.

13. The method of claim 10, wherein the message comprises at least one of: a voice message, text message, e-mail or phone call.

14. The method of claim 10, wherein the message comprises at least one of: a pre-recorded message or a pre-written message.

15. The method of claim 10, further comprising:
determining a location of the client device at a time of the triggering event; and
adding the location of the client device to the message.

16. The method of claim 15, further comprising identifying a physical address associated with the location.

17. The method of claim 10, further comprising:
accessing a health record associated with the user; and
adding a portion of the health record to the message.

18. The method of claim 10, wherein activating the mode of the client device, further comprises:
determining whether a current state of the client device is in at least one of: a hibernation mode, an airplane mode or a standby mode; and
switching the mode of the client device to an active mode based on the current state.

19. A non-transitory computer-readable storage medium comprising executable instructions that when executed, by a processing device, cause the processing device to:
receive, by the processing device, inertial sensor data related an impact of a client device from an impact sensor associated with the client device, the inertial sensor data indicating an amount of force applied to the client device with respect to the impact;
detect a triggering event based on the impact of the client device;
activate a mode of the client device based on the triggering event;
responsive to detecting the triggering event, generate a message indicating a status of user associated with the client device; and
transmit, via a network connection associated with the client device, the message to a receiver device based on the mode of the client device.

20. The non-transitory computer-readable storage medium of claim 19, wherein activation of the mode of the client device establishes the network connection.
